(19) United States
(12) Patent Application Publication
(10) Pub. No.: US 2006/0185172 A1
(43) Pub. Date: Aug. 24, 2006

(54) Utility knife

(75) Inventors: Robert J. Marshall, Wausau, WI (US); Jeremy Knopow, Hamburg, WI (US); Kevin Schmidt, Sun Prairie, WI (US); Chris DeSchamp, Evansville, WI (US)

Correspondence Address: FOLEY & LARDNER LLP, 321 NORTH CLARK STREET, SUITE 2800, CHICAGO, IL, 60610-4764, US

(73) Assignee: Fiskars Brands, Inc.

(21) Appl. No.: 11/254,645

(22) Filed: Oct. 20, 2005

Related U.S. Application Data
(60) Provisional application No. 60/621,218, filed on Oct. 21, 2004.

(51) Int. Cl. B26B 1/08

(52) U.S. Cl. 30/162; 30/335

(57) ABSTRACT

A knife system including a mechanism for automatically advancing a cutting blade. The knife system includes a click mechanism that a user is capable of selectively actuating. Each actuation of the click mechanism causes the cutting blade to become either exposed or unexposed. The knife system also includes a break off mechanism that aids a user in removing individual blade segments from the cutting blade.

The present application claims priority to U.S. Provisional Patent Application No. 60/621,218, filed Oct. 21, 2004 and incorporated by reference herein in its entirety.

### FIELD OF THE INVENTION

The present invention relates generally to utility knives. More particularly, the present invention relates to utility knives with blades that can be incrementally extended from the device by a user.

### BACKGROUND OF THE INVENTION

A number of knives using “break off” blades are conventionally known. In these knives, a user is capable of manually extending the blade as necessary and physically removing the front portion of the blade when the front portion becomes dulled, bent, or otherwise unusable.

Although such knives are known in the art, each have their own respective drawbacks. In several conventional knife systems, the user must literally take apart the knife to move the blade forward in order to have the blade exposed after a front segment has been removed. This is time consuming and also exposes the user to potential injury during this process. Other systems, while incorporating a rudimentary “blade advance” feature, are only capable of moving the blade forward and backward by a predetermined amount and are not able to incrementally move the blade forward such that a front segment can be broken off, while leaving the next segment of the blade exposed for immediate use. Furthermore, many conventional knife systems do not have any built-in mechanism for breaking off individual blade segments, instead requiring the user to break off the segments using his or her hands. This creates additional safety concerns.

It would therefore be desirable to develop a knife system that is easy to use, while addressing the above-identified shortcomings.

### SUMMARY OF THE INVENTION

It is therefore an object of the invention to provide an improved knife system that enables a user to quickly and easily extend a cutting blade from the unit as front segments of the blade become dulled, damaged, or otherwise unusable.

It is another object of the invention to provide an improved knife system that enables a user to extend a cutting blade without having to opening the unit.

It is still another object of the invention to provide an improved knife system that reduces the potential for user injury when the user is in the process of extending a cutting blade.

It is yet another object of the invention to provide an improved knife system that provides a mechanism for enabling a user to quickly and easily remove individual segments of a cutting blade.

In accordance with the above-identified objects, the present invention comprises a knife system including a “click assembly” that enables a user to quickly and easily extend a cutting blade that is operatively connected to the assembly. The click assembly is operatively connected to a blade advance biasing member. Actuation of the knob of the click assembly causes the cutting blade to alternately become available and unavailable for use.

The present invention provides a number of benefits not found in conventional systems. For example, the advancing mechanism used in the present invention provides a limited blade advancement system for everyday use, as well as virtually unlimited blade advancing and retracting for blade changing or breakoff. This is in sharp contrast to conventional systems, where the click function is typically used only for a fixed blade that is not capable of having individual segments removed or snapped off.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a utility knife according to one embodiment of the present invention;

FIG. 2 is a right side view of the utility knife of FIG. 1;

FIG. 3 is a top view of the utility knife of FIG. 1;

FIG. 4 is a left side view of the utility knife of FIG. 1;

FIG. 5 is a bottom view of the utility knife of FIG. 1;

FIG. 6 is a front view of the utility knife of FIG. 1;

FIG. 7 is a back view of the utility knife of FIG. 1;

FIG. 8 is an exploded view of the utility knife of FIG. 1;

FIG. 9 is a sectional side view of the rear portion of the utility knife of FIG. 1;

FIG. 10 is a side view of the click assembly of the utility knife of FIG. 1;

FIG. 11 is a sectional side view of the click assembly taken along lines A-A of FIG. 10;

FIG. 12 is a rear view of the click assembly of FIG. 10;

FIG. 13 is a perspective view of a portion of a click assembly body according to one embodiment of the present invention;

FIG. 14 is a perspective view of an indexer according to one embodiment of the present invention;

FIG. 15 is a perspective view of a positioner according to one embodiment of the present invention;

FIG. 16 is a perspective view of a click mechanism when the click mechanism is in the retracted position;

FIG. 17 is a perspective view of the click mechanism of FIG. 16 as the knob is in the process of being actuated and moved towards the positioner and the indexer;

FIG. 18 is a perspective view of the click mechanism of FIG. 16 as the knob is fully actuated;

FIG. 19 is a perspective view of the click mechanism of FIG. 16 as the knob is in the process of being retracted;

FIG. 20 is an exploded view of an additional embodiment of the click system of the present invention; and

FIG. 21 is a view of the knife of FIG. 20 with the second body portion removed.

### DETAILED DESCRIPTION OF THE PREFERRED EMBODIMENTS

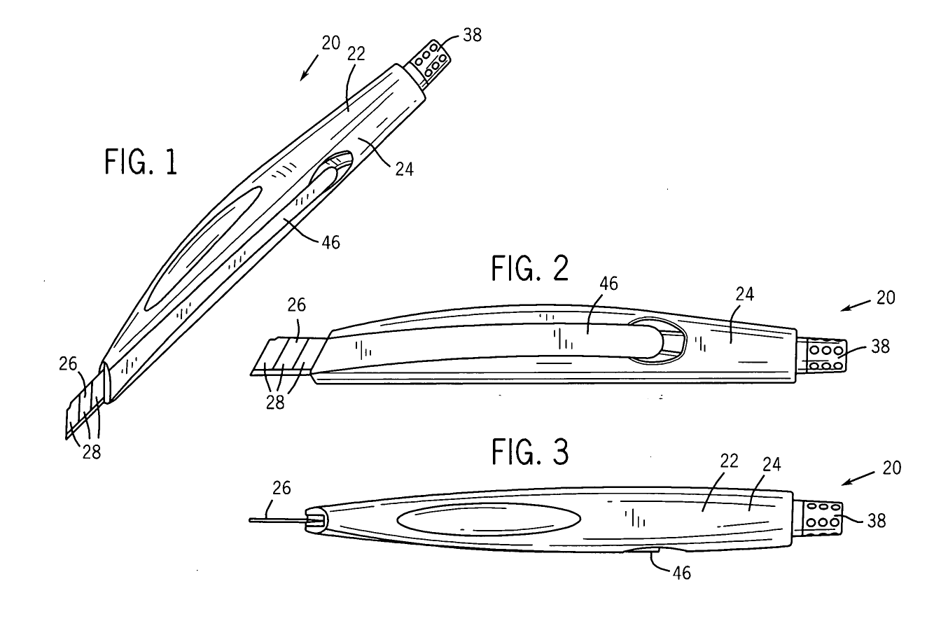

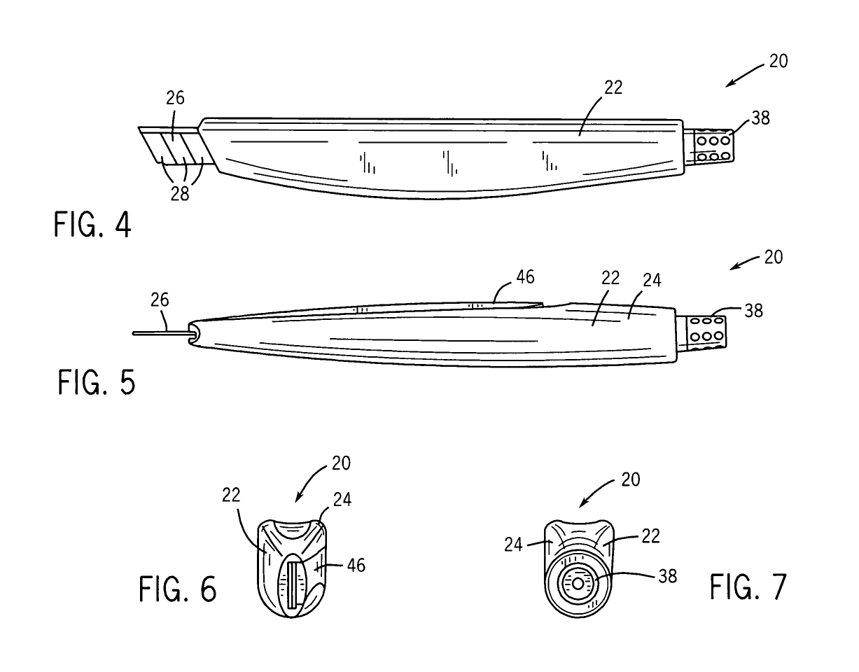

A knife assembly constructed in accordance with the principles of the present invention is shown at 20 in FIGS. 1-8. The knife assembly 20 includes a housing 21 having a first body portion 22 and a second body portion 24. A cutting blade 26 is positioned between the first body portion 22 and the second body portion 24 and is extendible through the front end of the knife assembly 20. As shown in FIGS. 1, 2 and 4, the cutting blade 26 can include a plurality of cutting blade segments 28. The cutting blade segments 28 are capable of being physically broken off from the remainder of the cutting blade 26, so that the user can continue to use the cutting blade in the event that an individual cutting blade segment becomes bent, dulled, or otherwise unusable.

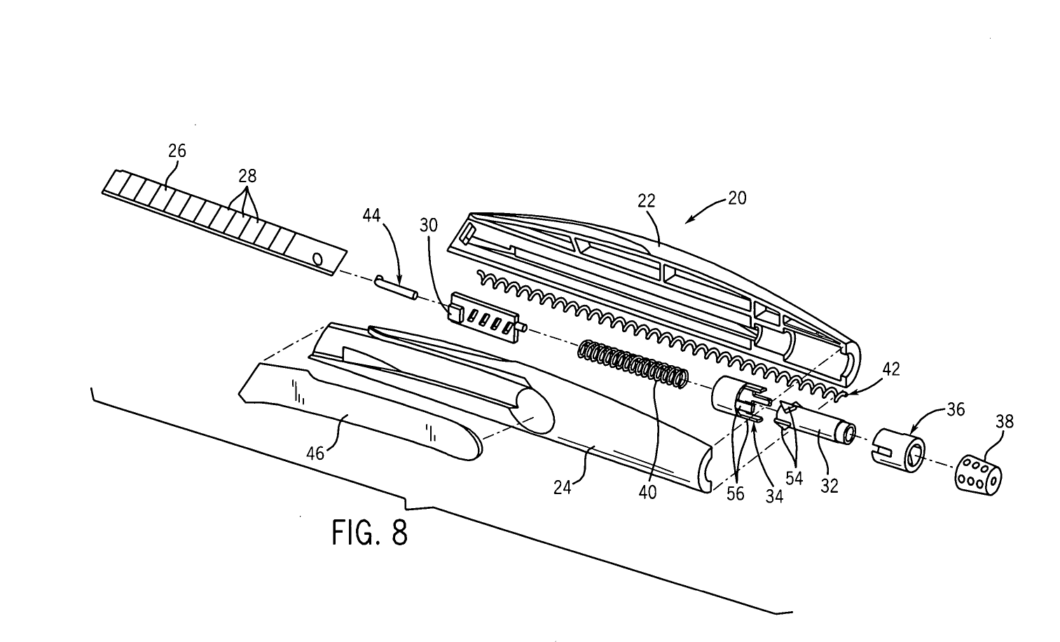

As is shown in FIG. 8, the cutting blade 26 is engageable with a follower 30 via a blade holder 44. As the blade holder 44 is operatively connected to the cutting blade 26 at one end and the follower 30 at the other end, any movement of the follower 30 results in a commensurate movement of the cutting blade 26. The follower 30 engages a blade advance biasing member 42 at an end opposite the blade holder 44.

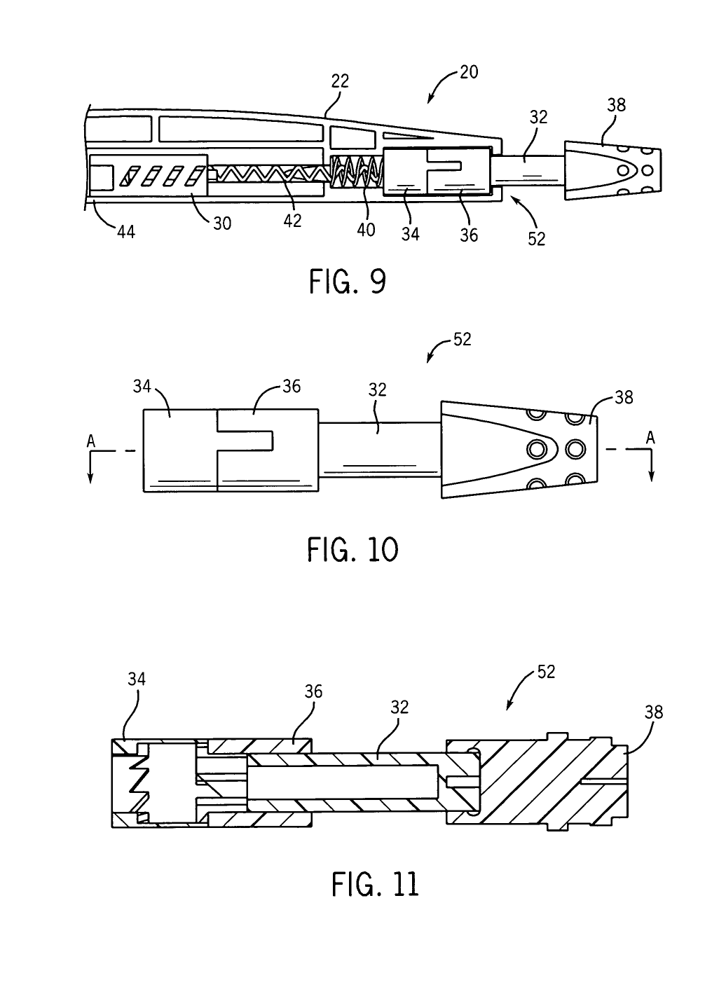

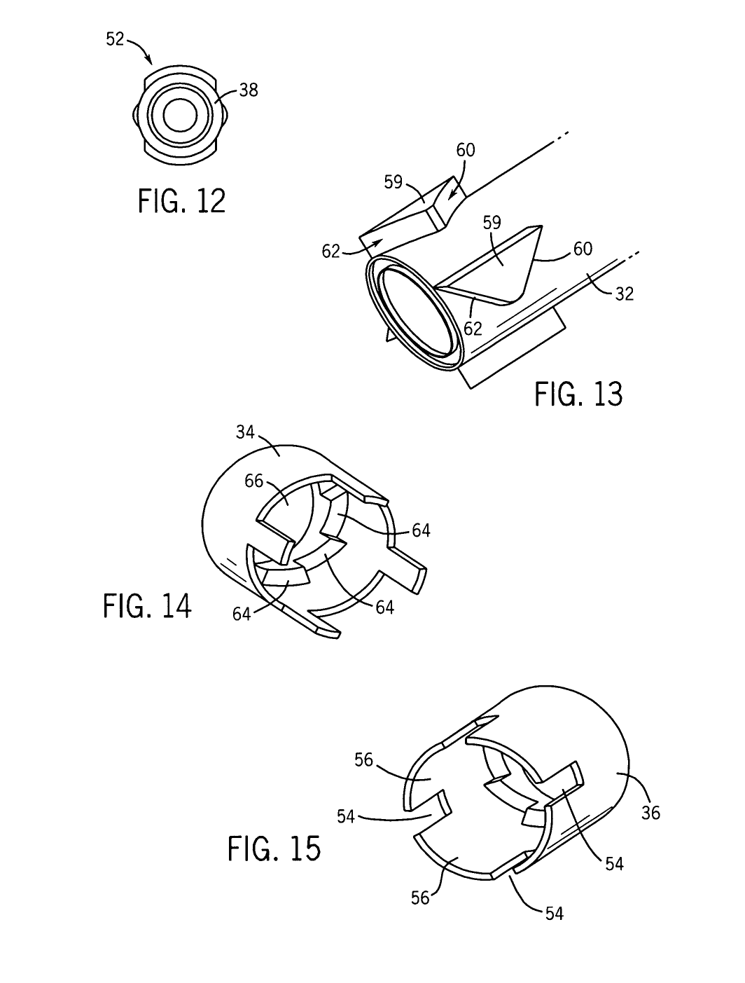

The opposite end of the blade advance biasing member 42 engages a click assembly 52. One embodiment of the click assembly 52 is shown in detail in FIGS. 9-12. The click assembly 52, in one embodiment of the invention, comprises a click assembly body 32, an indexer 34, a positioner 36 and a knob 38. In one embodiment of the invention, the indexer 34 and the positioner 36 are bonded or coupled together so as to capture a portion of the click assembly body 32. It is also possible for the indexer 34 and the positioner 36 to be coupled to each other by some other mechanism besides bonding. The click assembly body 32 is capable of sliding within the indexer 34 and the positioner 36. The knob 38 is coupled to an end of the click assembly body 32 opposite the indexer 34 and the positioner 36 such that movement of the knob 38 results in a corresponding movement of the click assembly body 32. The knob 38 is positioned outside of the first and second body portions 22 and 24 so as to be actuable by the user.

As can be seen in FIGS. 13 and 16-19, the click assembly body 32 includes a plurality of body ramps 59 each having a positioner side 60 and an indexer side 62. As shown in FIGS. 14 and 16-19, the indexer 34 includes a plurality of indexer ramps 64 for selective engagement with the plurality of the indexer side 62 of the plurality of the body ramps 59. The indexer 34 also includes a hole 66 so as to permit a click assembly biasing member 40 (see FIG. 8) to contact and bias the click assembly body 32. As shown in FIGS. 15-19, the positioner 36 includes a plurality of extended position slots 54, as well as a plurality of retracted position slots 56.

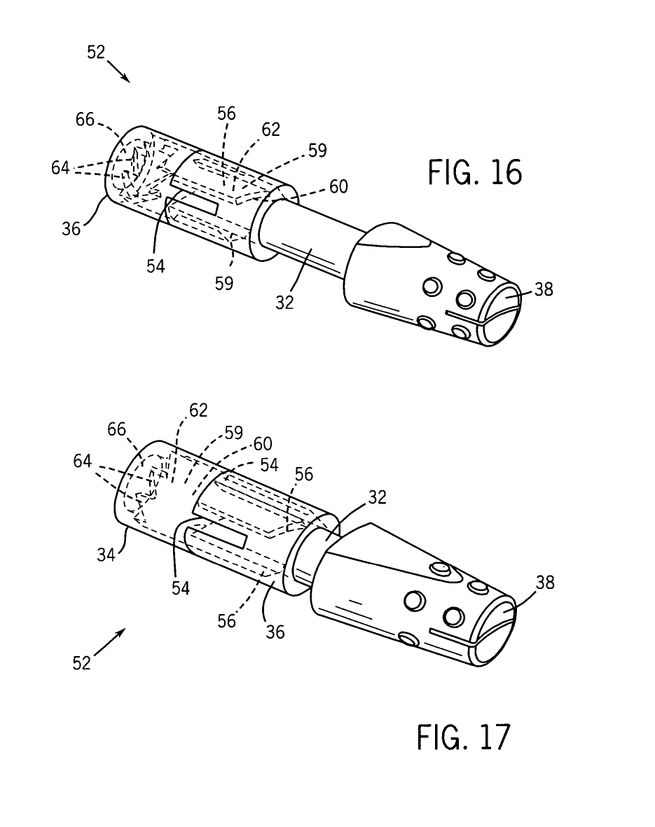

The operation of the click assembly 52 is generally as follows and as depicted in FIGS. 16-19. When the click assembly 52 is in a fully retracted position, shown in FIG. 16, each of the body ramps 59 is fully engaged within a respective retracted position slot 56 of the positioner 36 such that each of the positioner sides 60 of the body ramps 59 contact the positioner 36. In this position, the cutting blade is not exposed outside the remainder of the knife assembly 20. When the knob 38 is pressed by the user and as represented in FIG. 17, the click assembly body 32 moves forward and the plurality of the body ramps 59 move through the retracted position slots 56 and towards the plurality of the indexer ramps 64. When the body ramps 59 contact the indexer ramps 64, the indexer 34 and the positioner 36 pivot as the indexer side 62 of each the plurality of the body ramps 59 engage the plurality of indexer ramps 64. The forward movement of the click assembly body 32 causes the blade advance biasing member 42 to act against the follower 30, ultimately causing the cutting blade 26 to incrementally advance.

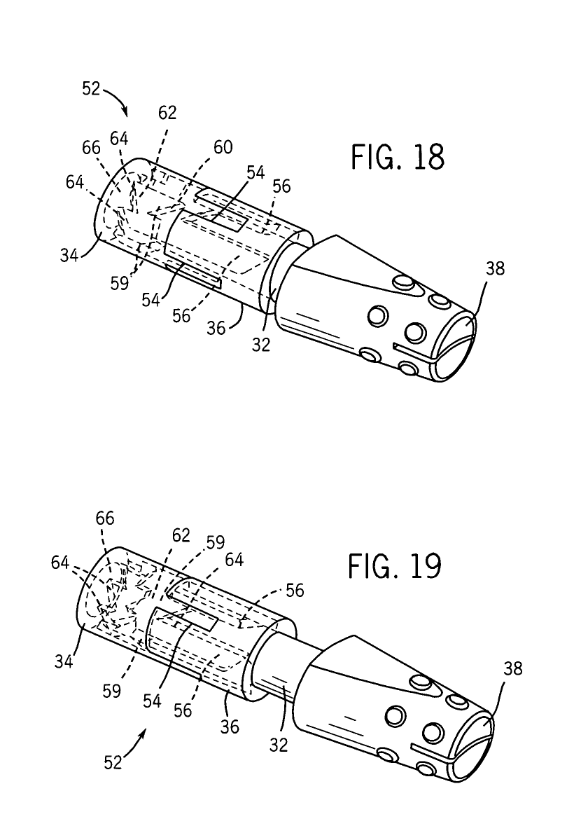

In the position shown in FIG. 18, the body ramps 59 have fully engaged slots defined by the indexer ramps 64, temporarily fixing the position of the click assembly body 32 relative to the indexer 34 and the positioner 36. When in this position, the body ramps 59 are slightly offset relative to the extended position slots 54. When the user releases pressure on the knob 38, the click assembly body 32 retracts due to the forces exerted by the click assembly biasing member 40, the positioner side 60 of the body ramps 59 contact the extended position slots 54. This is shown in FIG. 19. The offset between the body ramps 59 and the extended position slots 54 causes the indexer 34 and the positioner 36 to rotate until the body ramps 59 fully side the extended position slots 54. At this position, the click assembly body 32 is partially, but not fully retracted. As a result, the blade advance biasing member 42 is also partially, but not fully retracted. In this position, the cutting blade 26 is exposed for use.

When the user presses the knob 38 once more, the same process generally occurs, but the end result (after the knob 38 is released) is that the body ramps 59 have entered retracted position slots 56 (as shown in FIG. 16) instead of extended position slots 58 (as shown in FIG. 18). Because the retracted position slots 56 are deeper than extended position slots 58, in this position the click assembly body 32 is farther retracted than in the position shown in FIG. 18, which ultimately also causes the cutting blade 26 to be retracted into the knife assembly 20.

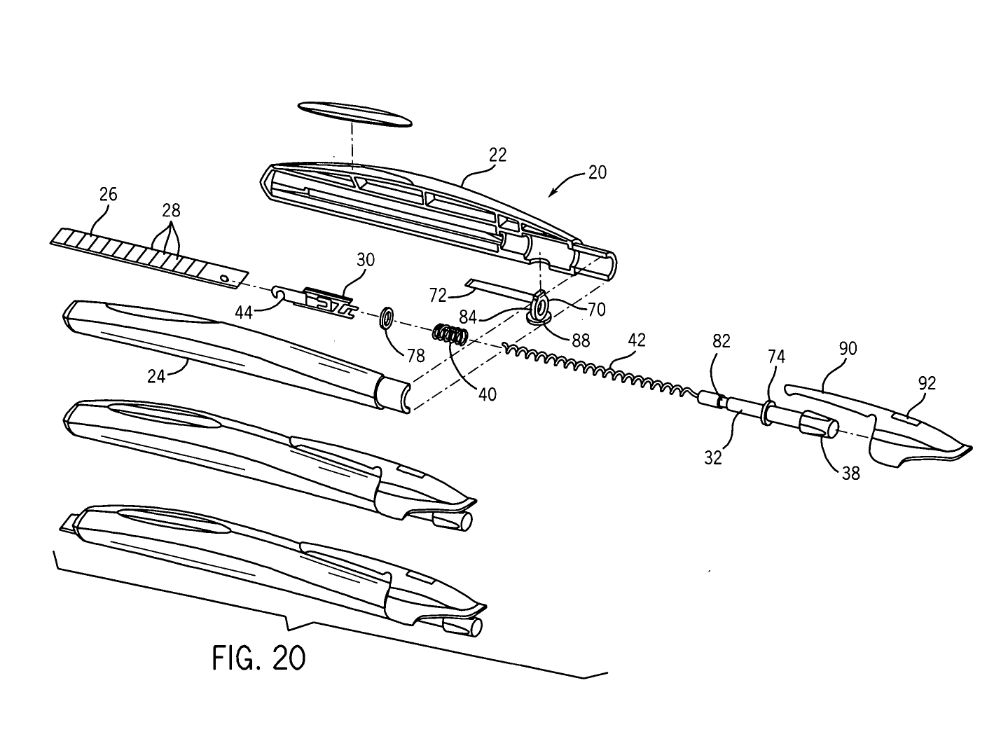

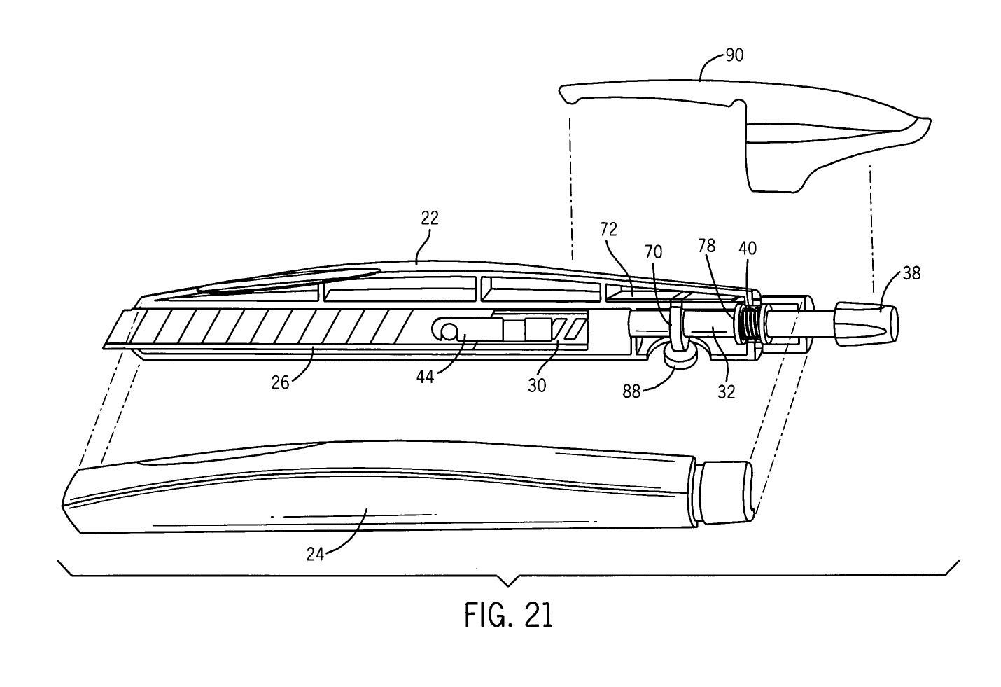

Another exemplary embodiment of the click assembly 52 is shown in FIGS. 20 and 21. In the embodiment of FIGS. 20 and 21, the click assembly 52 includes the click assembly body, 32, a knob 38, a knob biasing assembly 76, a catch member 70, and a catch member bias assembly 72. In one embodiment, the knob 38 and click assembly body 32 are fixedly connected to each other. The click assembly body 32 includes a click assembly body stop 74 for retaining the click assembly body 32 substantially within the knife assembly 20. The click assembly body 32 is capable of sliding within the knife assembly 20. The knob 38 is coupled to an end of the click assembly body 32 such that movement of the knob 38 results in a corresponding movement of the click assembly body 32. The knob 38 is positioned outside of the first and second body portions 22 and 24 so as to be actuable by a user. The knob bias assembly 76 biases the knob 38 and click assembly body 32 to an extended position, where the knob 38 is positioned away from the body portions 22 and 24 and the click assembly body stop 74 is engaging the first and second body portions 22 and 24. In one embodiment, a coil spring 40 engages the spring stop 78 and the click assembly body stop 74. The spring stop 78 is fixed in relation to the body portions 22 and 24 so that the spring 40 exerts force on the click assembly body stop 74 to bias the click assembly body 32 and the knob 38 away from the blade 26. The click assembly body 32 is affixed to the blade advance biasing member 42 and thus in communication with the blade 26 so that movement of the click assembly body 32 slides the blade 26.

A catch member 70 is at least partially disposed along a side of either the first body portion 22, the second body portion 24, or therebetween. In one embodiment, the catch member extends slightly beyond the body portion in which it resides. The catch member 70 is adapted to engage the click assembly body 32 in order to retain the click assembly body 32 in place when a user depresses the knob 38. In one embodiment, the click assembly body 32 includes a detent groove 82 for engagement by the catch member 70. In one embodiment, the click assembly body 32 includes an aperture 84 through which the click assembly body 32 slidably moves when the knob 38 is depressed. A catch member biasing assembly biases the catch member 70 against the click assembly body 32 wherein when the click assembly body 32 has slid sufficiently to align the detent groove 82 with the catch member 70, the catch member engages the groove 82 and locks the click assembly body 32 (and therefore the blade 26) in place. The catch member 70 may be disengaged from the groove 82 by depressing a button portion 88 of the catch member 70 to shift the catch member 70 from the detent groove 82, allowing the click assembly body 32 to slide (as biased by the click assembly bias assembly 72).

If a user desires to extend the cutting blade 26 in order to expose new ones of the blade segments 28, the user rotates the entire click assembly 52 by turning the knob 38. The rotation of the click assembly causes the blade advance biasing member 42 to rotate as well. In this situation, the blade advance biasing member 42 acts as a screw, which causes the follower 30 and connected components to advance.

In one embodiment, the knife assembly 20 includes a break off portion. In one exemplary embodiment, the break off portion includes a break off lever 46 which is coupled to the second body portion 24 of the knife assembly according to one embodiment of the present invention. When a user needs to remove a cutting blade segment 28 from the cutting blade 26, the user pulls the break off lever 46 away from a receiving region 48 on the second body portion 24. This motion causes a break off end 50 of the break off lever 46 to contact the cutting blade 26. This focused force of the break off lever 46 against the cutting blade 26 causes the blade segments 28 in front of the contact point to break off from the rest of the cutting blade 26.

In another exemplary embodiment, the break off portion includes a collar 90 which is removably attachable to the housing 18. The collar 90 includes a slot 92 adapted to receive the blade 26. In use, a user removes the collar 90 from the housing 21 and inserts the end of the blade 26 into the slot 92. The user bends the blade 26 with sufficient force with respect to the collar 90 to remove at least one of the cutting blade segments 28.

While several embodiments have been shown and described herein, it should be understood that changes and modifications can be made to the invention without departing from the invention in its broader aspects.

We claim:

1. A knife having a retractable blade, comprising:
a housing having a first body portion and a second body portion;
a blade positioned between the first body portion and the second body portion and extendable through an opening in a first end of the housing;
a blade advance biasing member operatively connected to the blade; and
a click assembly body including a knob positioned outside of the housing at a first end opposite the blade, the click assembly body coupled to the blade advance biasing member,
wherein movement of the click assembly body within the housing results in a corresponding movement of the blade.

2. The knife of claim 1, wherein the click assembly body engages an indexer and a positioner in communication with each other, and wherein the indexer and positioner are coupled together with the click assembly body slidably passing therethrough such that movement of the knob results in a corresponding movement of the click assembly body.

3. The knife of claim 2, wherein the click assembly body further comprises a plurality of body ramps each having a positioner side and an indexer side, and wherein the indexer includes a plurality of indexer ramps for selective engagement with the indexer side of the plurality of the body ramps.

4. The knife of claim 3, wherein the positioner includes a plurality of extended position slots and a plurality of retracted position slots.

5. The knife of claim 1, wherein the blade advance biasing member is in communication with the blade via a blade holder and a follower having a hole configured to receive the click assembly biasing member.

6. The knife of claim 5, wherein the blade advance biasing member comprises a screw, whereby rotation of the click assembly causes the blade advance biasing member to rotate, engaging the hole of the follower and moving the blade.

7. The knife of claim 1, further comprising a blade break off portion positioned to selectively engage the blade.

8. The knife of claim 7, wherein the break off portion includes a breakoff lever having a first end attached to the first end of the housing further wherein the breakoff lever exerts force on the blade to remove at least one of a plurality of blade segments of the blade when a second end of the breakoff lever is pulled away from the housing.

9. The knife of claim 7, wherein the break off portion comprises a collar removably engageable with the housing and having a slot configure to receive the blade during removal of one of a plurality of blade segments of the blade.

10. The knife of claim 1, wherein the click assembly further includes a catch member at least partially disposed along a side of the housing, the catch member configured to releasably engage a groove on the click assembly body to prevent movement of the catch member.

11. A knife assembly comprising
a housing having a first body portion and a second body portion;
a blade positioned between the first portion and the second portion and extendable through an opening in a first end of the housing;
a blade advance biasing member operatively connected to the blade;
a blade break off portion configured to engage the blade for removal of at least one of a plurality of blade segments of the blade;
a click assembly body slidably positioned within the housing; and
a knob operatively connected to the click assembly body,
wherein movement of the knob results in a corresponding movement of the click assembly body.

12. The knife of claim 11, wherein the click assembly body further comprises a plurality of body ramps each having a positioner side and an indexer side, and further comprising a plurality of indexer ramps for selective engagement with the indexer side of the plurality of the body ramps.

13. The knife of claim 11, wherein the blade advance biasing member comprises a screw, whereby rotation of the click assembly causes the blade advance biasing member to rotate, thereby engaging a follower and moving the blade.

14. The knife of claim 11, wherein the blade advance biasing assembly comprises a follower engageable with the blade via a blade holder, the blade holder operatively connected to the cutting blade at a first end and the follower at a second end, and wherein movement of the follower moves the blade.

15. A knife assembly comprising:
a housing having a first body portion and a second body portion;
a blade positioned between the first portion and the second portion and extendable through an opening in a first end of the housing;
a blade advance biasing assembly operatively connected to the blade;
a click assembly body having a knob positioned outside of the housing at a first end opposite the blade, the click assembly body coupled to the blade advance biasing assembly; and
a catch member at least partially disposed along a side of the housing, the catch member configured to releasably engage a groove on the click assembly body.

16. The knife of claim 15, wherein the blade advance biasing member communicates with the blade via a blade holder and a follower having a hole configured to receive the click assembly biasing member.

17. The knife of claim 16, wherein the blade advance biasing member comprises a screw, whereby rotation of the click assembly causes the blade advance biasing member to rotate, thereby engaging the follower and moving the blade.

18. The knife of claim 15, further comprising a blade break off portion positioned to selective engage the blade.

19. The knife of claim 18, wherein the blade break off portion includes a break off lever having a first end attached to the first end of the housing, and wherein the breakoff lever exerts force on the blade to remove a cutting blade segment when a second end of the breakoff lever is pulled away from the housing.

20. The knife of claim 18, wherein the blade break off portion comprises a collar removably engageable with the housing and having a slot configure to receive the blade during removal of a cut blade segment.
